(19) United States
(12) Patent Application Publication
(10) Pub. No.: US 2026/0336083 A1
(43) Pub. Date: Oct. 29, 2026

(54) Hammer drill or chisel hammer with a vibration-reduced striking mechanism

(71) Applicant: Hilti Aktiengesellschaft, Schaan (LI)

(72) Inventors: Uto PLANK, Freising (DE); Josef FÜNFER, Koenigsbrunn (DE)

(21) Appl. No.: 19/099,165

(22) PCT Filed: Aug. 3, 2023
(86) PCT No.: PCT/EP2023/071490

§ 371 Date: Jan. 28, 2025

(30) Foreign Application Priority Data
Aug. 18, 2022 (EP) 22190886.6

(51) Int. Cl. B25D 11/12

(52) U.S. Cl. CPC B25D 11/12; B25D 2250/095; B25D 2250/245

(57) ABSTRACT

A hammer drill or chisel hammer having a striking mechanism unit, including a drive motor with a motor axis, arranged transversely to a striking mechanism axis, for generating a rotational drive movement which a subsequent eccentric gear converts into a linearly alternating working movement along the striking mechanism axis, which movement can be transmitted to a coaxially adjacent tool via a striking mechanism connected thereto, wherein the center of gravity of the drive motor is arranged at a radial distance from the striking mechanism axis and the center of gravity of the eccentric gear is arranged at an opposite radial distance from the striking mechanism axis in order to reduce vibration, wherein the radial distance of the drive motor as well as the radial distance of the eccentric gear is dimensioned in such a way that a balanced mass distribution is established with respect to the striking mechanism axis.

### DESCRIPTION

The present invention relates to a hammer drill or chisel hammer.

### BACKGROUND

The field of application of the invention extends primarily to hand-held hammer drills or chisel hammers, which are primarily provided with an electric motor drive. Such electric hand tools generate a linear alternating working movement via a mechanical striking mechanism unit, i.e., a reciprocating movement for impacting the tool, which in the case of a chisel hammer is designed as a mortise chisel and in the case of a hammer drill as a percussion drill for working on preferably mineral materials-such as stone, concrete and the like.

### SUMMARY OF THE INVENTION

Due to the interaction with the workpiece and the hand-arm system of the operator as well as the internal mass and stiffness distribution, an electric hand tool driving a tool has a complex self-excitation whose resulting inherent vibration, in particular in the handle region, must be suppressed as far as possible. The technical complexity of such passively damping or actively controlled vibration suppression increases in line with the complexity of the self-excitation to be compensated.

In order to ensure the most controlled and fatigue-free handling of such electric machine tools, the striking mechanism should thus be as vibration-free as possible.

EP 1 431 005 A2 discloses a generic electric hand tool provided with an electric motor having a rotor shaft arranged transversely to the striking axis and with a rotor laminated core and a motor pinion which drives a striking mechanism by means of an eccentric gear via a spur wheel stage, wherein the rotor laminated core is arranged completely diametrically to the striking mechanism gear with respect to the striking axis. As a result, only the rotor shaft passes through the core region of the striking axis, which, in addition to a mass distribution acting radially opposite the striking mechanism axis, means that the electric motor is arranged close to the eccentric and thus less vibration-causing bending moments are induced. By arranging the eccentric gear with spur wheel stage on the one hand and the drive motor on the other hand opposite one another with respect to the striking mechanism axis, vibrations are reduced to a certain extent.

Since the mass of the drive motor increases disproportionately as the power class of a hammer drill or chisel hammer increases, the vibration reduction effect explained above is correspondingly weakened, which impairs manageability in particular in the case of heavy electric hand tools of the type of interest here.

It is an object of the present invention to further improve a generic hammer drill or chisel hammer in such a way that effective vibration reduction is achieved across all power classes by simple technical means.

The present invention provides a hammer drill or chisel hammer having a striking mechanism unit, comprising a drive motor (1) with a motor axis (A_{M}), arranged transversely to a striking mechanism axis (A_{S}), for generating a rotational drive movement which a subsequent eccentric gear (5) converts into a linearly alternating working movement along the striking mechanism axis (A_{S}), which movement can be transmitted to a coaxially adjacent tool via a striking mechanism (9) connected thereto, wherein the center of gravity (S_{M}) of the drive motor (1) is arranged at a radial distance (S_{M}) from the striking mechanism axis (A_{S}) and the center of gravity (S_{G}) of the eccentric gear (5) is arranged at an opposite radial distance (S_{G}) from the striking mechanism axis (A_{S}) in order to reduce vibration,
characterized in that the radial distance (S_{M}) of the drive motor (1) as well as the radial distance (S_{G}) of the eccentric gear (5) is dimensioned in such a way that a balanced mass distribution is established with respect to the striking mechanism axis (A_{S}).

The invention includes the technical teaching that the radial distance of the drive motor as well as the radial distance of the eccentric gear of the striking mechanism unit from the striking mechanism axis is dimensioned in such a way that a balanced mass distribution with respect to the striking mechanism axis is established. This means that the relative distance of the respective component is selected according to its mass so that the overall center of gravity of the striking mechanism unit lies on the striking mechanism axis.

The advantage of the solution according to the invention is in particular that a balanced mass distribution with respect to the striking mechanism axis can be achieved solely through optimized adjustment of the said radial distances. Since there is consequently no acceleration of the striking mechanism unit in the transverse direction, minimal vibration is achieved.

According to a first preferred design, it is proposed that the drive motor is arranged completely behind an eccentric unit of the eccentric gear, as viewed along the striking mechanism axis. As a result, the dead weight of the drive motor no longer plays a limiting role, since the drive motor can be positioned freely in the transverse direction to create the desired mass balance in relation to the normally lighter eccentric gear. This is because the eccentric gear does not prevent the drive motor from being positioned in the transverse direction in this design, and vibration reduction can also be achieved with relatively heavier drive motors when this design is used.

According to an alternative design, it is proposed to arrange the drive motor, with the exception of the motor shaft, completely radially offset next to the eccentric gear, as viewed along the striking mechanism axis. This design is suitable for striking mechanism units that are to be as short as possible. Since in this case there is little scope for varying the radial distance of the drive motor from the striking mechanism axis, this variant is suitable in particular for relatively light drive motors. However, in this case, the eccentric gear can also have a further influence on the balanced mass distribution. In particular, the transmission gear of the eccentric gear could have a relatively heavy design for the purpose of mass balancing. On the other hand, this design allows for a transmission gear with relatively small gearwheels, since the axis-center distance to be bridged is smaller than in the design described above, which in particular also reduces the overall width of the electric hand tool. The optimum depends on the design objectives and is dependent on the influencing parameters discussed above.

According to a preferred embodiment of the invention, when the first design mentioned above is used, the radial distance between the motor center of gravity and the striking mechanism axis is smaller than the radial distance between the eccentric gear center of gravity and the striking mechanism axis. This means that a drive motor can be used which normally has a higher mass than a normal eccentric gear. In this respect, there is no need to influence the design of the drive motor or the eccentric gear itself by making certain components particularly light or particularly heavy in order to achieve the desired balanced mass distribution in the overall framework of the striking mechanism unit.

This does not affect the fact that these components are also designed to be weight-optimized in order to achieve a balanced mass distribution not only by means of distance control. The drive motor is preferably designed as an electric motor and its mass is substantially determined by the power class. However, the dead weight can be influenced by using brushless electric motors, which are normally relatively lighter in the same power class.

With regard to the eccentric gear, a single-stage transmission gear is preferably used for transmission to low speed, and is very preferably designed as a spur wheel stage. To achieve the highest possible transmission ratio, it is sufficient if the motor shaft is designed at the distal end as a toothed pinion with preferably more than ten teeth. The diameter of the corresponding spur wheel of the transmission gear depends on the axis-center distance between the motor axis and the eccentric gear main axis and is substantially dependent on the stroke of the eccentric connecting rod and the motor diameter. As already mentioned, however, this only applies when the aforementioned first design of a striking mechanism unit is implemented. To vary the mass of the eccentric gear, the spur wheel of the transmission gear can be made of a heavy steel material or a lightweight plastic material. Since the spur wheel is arranged on the outside in the radial direction, its dead weight has a significant effect on the mass distribution with respect to the striking mechanism axis.

Preferably, a striking mechanism unit of a hammer drill or chisel hammer according to the invention is designed in such a way that, in a desired working position held by an operator, the drive motor has a smaller ground clearance—i.e., the distance from the floor—than the eccentric gear. Since the drive motor protrudes further from the striking mechanism axis in the radial direction, this lower positioning is more convenient for the operator than a lateral or upper positioning. The entire striking mechanism unit is surrounded by a device housing with a handle and has a tool holder at the distal end for the chisel or percussion drill. The entire striking mechanism unit is surrounded by a device housing with a handle piece and has a tool holder at the distal end for the chisel or percussion drill.

### BRIEF DESCRIPTION OF THE DRAWINGS

Further measures improving the invention are explained in more detail below together with the description of preferred exemplary embodiments of the invention with reference to the figures. In the drawings:

FIG. 1 shows a schematic side view of a striking mechanism unit according to the first design, and

FIG. 2 shows a schematic side view of a striking mechanism unit according to the second design.

### DETAILED DESCRIPTION

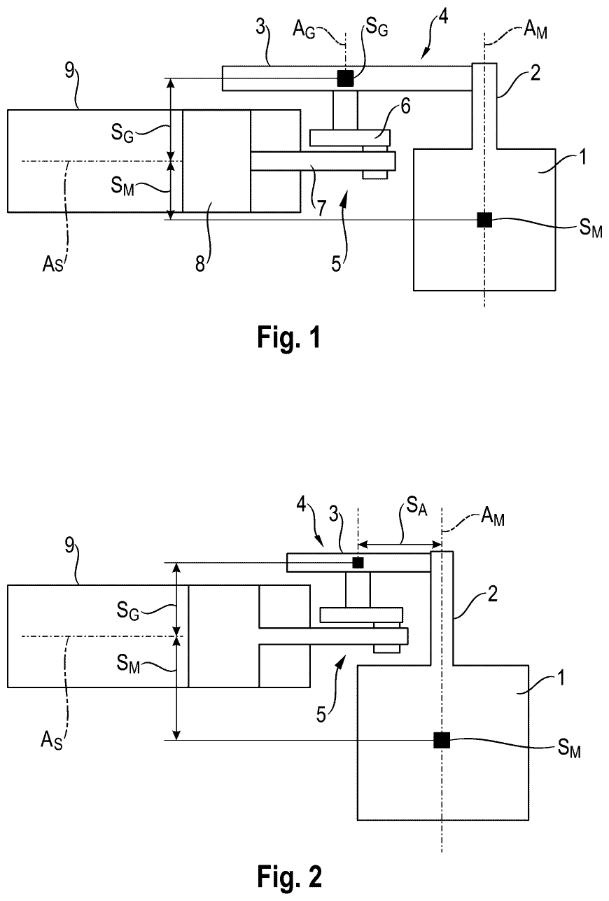

According to FIG. 1, the striking mechanism unit of a chisel hammer according to the first, preferred design consists of a drive motor 1, with a motor axis A_{M} arranged transversely to a striking mechanism axis A_{S}, for generating a rotational drive movement. The drive motor 1 is designed as an electric motor and has at the distal end of a motor shaft 2 a pinion tooth system which meshes with a spur wheel 3 of a single-stage transmission gear 4.

The single-stage transmission gear 4 is part of an eccentric gear 5 connected downstream of the drive motor 1. For generating a linearly alternating working movement, the eccentric gear 5 has an eccentric wheel 6 connected downstream of the transmission gear 4 and having a connecting rod 7 as well as an exciter piston 8 arranged on the striking mechanism side. The exciter piston 8 is also part of a striking mechanism 9, which transmits the working movement to a coaxially arranged tool—not shown in further detail.

To reduce vibrations of the striking mechanism unit, the center of gravity S_{M} of the drive motor 1 is arranged at a radial distance S_{M} from the striking mechanism axis A_{S} and the center of gravity So of the eccentric gear 5 is arranged at an opposite radial distance SG from the striking mechanism axis A_{S}. In this case, the radial distance S_{M} of the drive motor 1 as well as the radial distance So of the eccentric gear 5 is dimensioned in such a way that a balanced mass distribution is established with respect to the striking mechanism axis A_{S}.

In the illustrated design of the striking mechanism unit, the drive motor 1 is arranged completely behind the eccentric gear 5 as viewed along the striking mechanism axis A_{S}. Although this means that the electric hand tool of this embodiment has a correspondingly long design, there is a wide variation with regard to the radial distances. In this embodiment, the radial distance S_{M} is smaller than the radial distance SG, such that a drive motor 1 with a relatively high mass can be positioned in a correspondingly balanced manner relative to the eccentric gear 5.

According to the alternative design illustrated in FIG. 2, the drive motor 1, with the exception of the motor shaft 2, is arranged completely radially offset next to the eccentric gear 5, as viewed along the striking mechanism axis A_{S}. Consequently, the striking mechanism unit is more compact than the design described above, but the resulting larger radial distance S_{M} compared with the other distance So can be compensated for on the one hand by an electric motor which is as light as possible and on the other hand by a particularly heavy spur wheel 3 of the transmission gear 4. The more compact design translates in particular into a relatively small axis-center distance S_{A} between the motor axis and the spur wheel axis.

The invention is not limited to the two preferred exemplary embodiments described above. On the contrary, modifications thereof are also conceivable, which are encompassed by the scope of protection of the following claims. For example, it is also conceivable to combine the striking mechanism with a rotary drive about the striking mechanism axis in order to provide a hammer drill with the solution according to the invention.

### LIST OF REFERENCE SIGNS

1 Drive motor
2 Motor shaft
3 Spur wheel
4 Transmission gear
5 Eccentric gear
6 Eccentric wheel
7 Connecting rod
8 Exciter piston
9 Striking mechanism
A_{S} Striking mechanism axis
A_{M} Motor axis
S_{M} Center of gravity of motor
S_{G} Centre of gravity of eccentric gear
S_{M} Radial distance of motor
S_{G} Radial distance of eccentric gear
S_{A} Axis-center distance

What is claimed is:

1-10 (canceled)

11. A hammer drill or chisel hammer comprising:
a striking mechanism unit including:
a drive motor with a motor axis arranged transversely to a striking mechanism axis for generating a rotational drive movement; and
an eccentric gear converting the rotational drive movement into a linearly alternating working movement along the striking mechanism axis,
a striking mechanism, the linearly alternating movement transmittable to a coaxially adjacent tool via the striking mechanism,
a center of gravity of the drive motor arranged at a radial distance from the striking mechanism axis and a center of gravity of the eccentric gear arranged at an opposite radial distance from the striking mechanism axis in order to reduce vibration, the radial distance of the drive motor as well as the opposite radial distance of the eccentric gear being dimensioned in such a way that a balanced mass distribution is established with respect to the striking mechanism axis.

12. The hammer drill or chisel hammer as recited in claim 11 wherein the drive motor, viewed along the striking mechanism axis, is arranged completely behind the eccentric gear.

13. The hammer drill or chisel hammer as recited in claim 11 wherein the drive motor, with the exception of a motor shaft, is arranged completely radially offset next to the eccentric gear, as viewed along the striking mechanism axis.

14. The hammer drill or chisel hammer as recited in claim 11 wherein the drive motor has a higher mass than the eccentric gear, such that the radial distance is smaller than the radial distance.

15. The hammer drill or chisel hammer as recited in claim 11 wherein the eccentric gear has a single-stage transmission gear for lowering speed, the transmission gear being a spur wheel stage.

16. The hammer drill or chisel hammer as recited in claim 11 wherein for a variation in a dead weight of the eccentric gear, the spur wheel of the spur wheel stage consists of a steel or plastic material.

17. The hammer drill or chisel hammer as recited in claim 15 wherein the eccentric gear includes an eccentric wheel connected downstream of the transmission gear and having a connecting rod as well as an exciter piston arranged on the striking mechanism side.

18. The hammer drill or chisel hammer as recited in claim 11 wherein the drive motor is designed as an electric motor.

19. The hammer drill or chisel hammer as recited in claim 11 wherein the motor has a motor shaft formed at the distal end as a toothed pinion with more than ten teeth.

20. A method for operating the hammer drill or chisel hammer as recited in claim 11, the method comprising: operating the hammer drill or chisel hammer in a desired working position, the striking mechanism unit being designed in such a way that, in the desired working position held by an operator, the drive motor has a smaller ground clearance than the eccentric gear.
